(19) United States
(12) Patent Application Publication
(10) Pub. No.: US 2005/0158605 A1
(43) Pub. Date: Jul. 21, 2005

(54) Fuel cell and electronic device using it

(76) Inventors: Akira Tanaka, Mito (JP); Tomoichi Kamo, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/028,237

(22) Filed: Jan. 4, 2005

(30) Foreign Application Priority Data
Jan. 9, 2004 (JP) 2004-003546

(51) Int. Cl. H01M 8/10; H01M 8/24

(52) U.S. Cl. 429/32; 429/34

(57) ABSTRACT

An object of the present invention is to provide a fuel cell whose generated output can be prevented from decreasing owing to the influence of impurities present in fuel, by reducing the production of an electrical short circuit between single cells which make a potential difference larger than that made by any other two of a plurality of single cells which hold a fuel container in common and are located in a plane and face to face with each other with the fuel container inserted between them; and an electronic device using said fuel cell. The present invention consists in a fuel cell in which a plurality of single cells each obtained by forming an anode for oxidizing liquid fuel and a cathode for reducing oxygen, each in a planar form with an electrolyte membrane inserted between them are located face to face with each other with the aforesaid fuel between, said fuel cell being characterized by having at least one of a means for making the potential gradient between adjacent single cells among the above-mentioned single cells of planar form slighter than that given in the case of the linear distance between them and a means for making the potential gradient between the aforesaid single cells facing each other as described above slighter than that given in the case of the linear distance between them.

### INCORPORATION BY REFERENCE

The present application claims priority from Japanese application JP 2004-003546 filed on Jan. 9, 2004, the content of which is hereby incorporated by reference into this application.

### FIELD OF THE INVENTION

The present invention relates to a novel fuel cell and an electronic device using it.

Fuel cells are excellent in energy efficiency because they produce electric energy electrochemically and directly from fuel. Moreover, they are advantageous, for example, in that they are easily in harmony with the environment because the main substance discharged from them is water. Therefore, there have been attempts to use them in automobiles, distributed power sources, information electronic device and the like.

Under such circumstances, polymer electrolyte fuel cells (hereinafter referred to as PEFC), which generate electricity by oxidizing fuel such as hydrogen at the anode and reducing oxygen at the cathode by the use of a solid polymer membrane, are known as cells having a high power density. As an example of PEFC, there are direct methanol fuel cells (hereinafter referred to as DMFC) in which methanol is used as fuel. Since DMFC has an output voltage of 0.3 to 0.4 V per unit cell as a load, such fuel cells have to be connected in series by the use of a plurality of fuel containers attached thereto, in order to generate a voltage necessary to a portable electronic device or the like. In addition, the following problem still exists: in order to miniaturize an electric generator, the number of the cells connected in series has to be increased, so that the volume of the fuel container per unit cell has to be reduced and that the number of fuel containers is increased with an increase of the number of the cells connected in series.

DMFC can be broadly divided into laminate type cells and plane type cells according to the electric connection structure of an electrolyte membrane-electrodes assembly (membrane electrode assembly: hereinafter referred to as MEA). The laminate type DMFC has MEAs each obtained by forming an anode for oxidizing fuel and a cathode for reducing oxygen, with an electrolyte membrane inserted between them, and separators for supplying the fuel. Each MEA is held between the separators. The separators are electrically conductive for the utilization of generated electricity and function also as a current collector. Usually, grooves are formed in the separator as flow paths for supplying the fuel. Air flows on the cathode side and a gas produced by vaporizing methanol or the like or a liquid such as methanol flows as the fuel on the anode side. The fuel is forcedly sent into MEA with a pump or the like. The laminate type DMFC has a structure formed by laminating a plurality of such assemblies composed of MEA and the separators.

On the other hand, the plane type DMFC has a structure in which a plurality of MEAs are located on one and the same plane. Its cathode side is divided into a forced aeration type in which forced air introduction is carried out and a spontaneous aeration type in which the cathode surface is open to the air. The anode side is divided into a forced supply type in which forced introduction of methanol fuel is carried out and a spontaneous supply type in which methanol fuel stored in a fuel container is used. As a structure in which a vent hole is provided in the wall surface of each fuel container and a plurality of single cells each having an anode and a cathode are located in a plane, there is, for example, the structure disclosed in JP-A-2003-100315 (Patent document 1). In this case, a power source is miniaturized because the plurality of the single cells are located on a common fuel container.

When a plurality of single cells are located in a plane so as to hold a fuel container in common, in a so-called direct liquid fuel type fuel cell, a kind of PEFC, in which electricity is generated by directly oxidizing liquid fuel (for example, methanol, ethanol, diethyl ether or ethylene glycol), the fuel is shared among the single cells. As the components of the single cell, there are used, for example, a current-collecting plate composed mainly of nickel or copper and an end plate of stainless steel, titanium or the like for applying a pressure on surface to the single cell. From these components, metal ions are released into the fuel by dissolution.

When the metal ions are present as impurities in the fuel, they intrude into the electrolyte membrane. Since their hydrated state is different from that of hydrogen ions, the water content of the electrolyte is decreased. Therefore, the ion electric conductivity of the electrolyte membrane is liable to be decreased. In addition, the metal ions deteriorate the performance characteristic of the fuel cell because they adhere to the surface of a catalyst or cover the catalyst as an oxide. When the fuel cell is used in an information apparatus, different voltages are applied to the different single cells because the plurality of the single cells are used by electrically connecting them in series. Therefore, the release by dissolution of the metal ions varies depending on the single cells.

When the fuel container is used as a common one, the impurities such as the metal ions released by dissolution produce an electrical short circuit between adjacent single cells and moreover, adhere to normal single cells to deteriorate the performance characteristics of the whole power source. Thus, as the structure of a direct fuel cell for portable apparatus, a structure is desired which makes it possible to miniaturize the fuel cell by using a common fuel container and reduce the influence of the impurities (e.g. the metal ions) present in the fuel.

An object of the present invention is to provide a fuel cell whose generated output can be prevented from decreasing owing to the influence of impurities (e.g. metal ions) present in fuel, by reducing the production of an electrical short circuit between single cells (MEAs) which make a potential difference larger than that made by any other two of a plurality of single cells which hold a fuel container in common and are located in a plane and face to face with each other with the fuel container inserted between them; and an electronic device using said fuel cell.

### SUMMARY OF THE INVENTION

The present invention is characterized in that in a fuel cell comprising a plurality of single cells each obtained by forming an anode for oxidizing liquid fuel and a cathode for reducing oxygen with an electrolyte membrane inserted between them and a fuel container holding said fuel on which the single cells are integrally located, there is provided a means for making the potential gradient between adjacent single cells among the above-mentioned single cells slighter than that given in the case of the linear distance between them.

The present invention is characterized also in that in a fuel cell comprising a plurality of single cells each obtained by forming an anode for oxidizing liquid fuel and a cathode for reducing oxygen with an electrolyte membrane inserted between them and a fuel container holding said fuel on which the single cells are integrally located, there is provided a barrier layer for making the potential gradient between adjacent single cells among the above-mentioned single cells slighter than that given in the case of the linear distance between them.

In addition, in the present invention, the above-mentioned single cells are preferably located on said fuel container in a plane, or face to face with each other, or in a plane and face to face with each other.

Further, in the present invention, said means or barrier layer for making the potential gradient between the adjacent single cells slighter than that given in the case of the linear distance between them is preferably provided in at least one of the area between the aforesaid adjacent single cells located in a plane as described above and the area between the aforesaid single cells facing each other as described above; said means or barrier layer is preferably formed in one or more places or the whole of the area between the aforesaid adjacent single cells; and said means or barrier layer is preferably an insulating film formed on the whole surface in said fuel container in at least one of the area between the aforesaid single cells located in a plane as described above and the area between the aforesaid single cells located face to face with each other as described above, which insulating film is permeable or impermeable to fuel.

Said means or barrier layer for making the potential gradient between the adjacent single cells slighter than that given in the case of the linear distance between them preferably has two projections formed in the whole area between the aforesaid adjacent single cells located in a plane on each side as described above, and preferably has two projections formed in the whole area between the aforesaid adjacent single cells located in a plane on each side as described above, and a flat plate formed between the aforesaid projections between the aforesaid single cells located face to face with the single cells located on the other side, so as to provide a flow path for the above-mentioned fuel.

Said means or barrier layer for making the potential gradient between the adjacent single cells slighter than that given in the case of the linear distance between them is preferably an insulating porous layer formed at least between the aforesaid adjacent single cells located in a plane as described above. Said insulating porous layer is preferably formed on the whole surface in the above-mentioned fuel container. The aforesaid single cells are preferably located on said fuel container in a plane and face to face with each other, and said means or barrier layer is preferably an insulating porous layer formed on the whole surface in the said fuel container. Said means or barrier layer is preferably an insulating organic material.

Said means or barrier layer for making the potential gradient between the adjacent single cells slighter than that given in the case of the linear distance between them is preferably an insulating organic material.

The present invention is characterized in that in an electronic device incorporated with fuel cells, said fuel cells are composed of the fuel cells described above.

Other objects, features and advantages of the invention will become apparent from the following description of the embodiments of the invention taken in conjunction with the accompanying drawings.

### BRIEF DESCRIPTION OF DRAWINGS

FIG. 1 is a cross-sectional view of a fuel cell of the present invention.

FIG. 2 is a cross-sectional view of a comparative fuel cell.

FIG. 3 is a cross-sectional view of a fuel cell of the present invention having another structure.

FIG. 4 is a cross-sectional view of a fuel cell of the present invention having still another structure.

FIG. 5 is a block diagram showing the system of a personal computer incorporated with the fuel cell of the present invention.

FIG. 6 is a perspective view of a personal computer according to the present invention.

### DESCRIPTION OF REFERENCE NUMERALS

1—electrolyte membrane,
2—cathode,
3—anode,
4a, 4b, 4c and 4d—MEAs,
4ab—distance between MEA 4a and MEA 4b,
4ad—distance between MEA 4a and MEA 4d,
5 or 21—fuel container,
6—fuel,
7—barrier layer,
8—groove for aeration,
9—groove for liquid passage,
10—current-collecting plate,
11—gasket,
12—interconnector,
13—electroconductive paste,
14—fuel cell,
15—information,
16—sensors,
17—command,
18—pump,
19—introduction of fuel,
20—suction of fuel,
23—discharge of fuel.

### DETAILED DESCRIPTION OF THE INVENTION

As an anode catalyst constituting the power-generating portion, a carbon-based powder carrier supporting thereon dispersed fine particles of platinum and ruthenium or a platinum-ruthenium alloy is preferable. As a cathode catalyst, a carbon-based carrier supporting thereon dispersed fine particles of platinum is preferable. In addition, as the catalysts of the anode and cathode of the fuel cell of the present invention, catalysts containing a third component selected from iron, tin, rare earth elements and the like are preferably used for stabilizing the electrocatalysts and lengthening their life.

As the electrolyte membrane, a membrane having hydrogen ion electroconductivity is preferably used. As a typical material for the electrolyte membrane, there can be used sulfonated or alkylenesulfonated fluorine-containing polymers represented by perfluorocarbon-based sulfonic acid resins, polyperfluorostyrene type sulfonic acid resins, polystyrenes, polysulfones, polyether sulfones, polyether ether sulfones, polyether ether ketones, and materials obtained by sulfonating other hydrocarbon polymers.

The shape of section of the fuel container for accommodation of liquid fuel of the fuel cell of the present invention is not particularly limited so long as it makes it possible to attach a necessary number of single cells compactly to the fuel container, though a square shape, a round shape or the like is preferable as the shape of section because such a shape improves not only the efficiency of the attachment but also the processability. As a material for the fuel container, any material may be used so long as it is electrochemically inactive, has sufficient durability and corrosion resistance in a use environment, and has a sufficient strength at a small thickness. As the material, there can be exemplified polyethylenes, polypropylenes, polyethylene terephthalates, vinyl chloride, polyacrylate resins, other engineering resins, electrical insulating materials obtained by reinforcing these materials with various fillers or the like, carbon materials excellent in corrosion resistance in an atmosphere in which the cell works, stainless steel, carbon steel, nickel, copper, aluminum, and materials obtained by subjecting the surface of an alloy of these metals to a treatment for imparting corrosion resistance and electrical insulating properties.

Moreover, in the present invention, a high voltage can be attained by using the fuel container as a platform and connecting a plurality of single cells each composed of an anode, an electrolyte membrane and a cathode, in series on the peripheral surface of the fuel container by the use of an electroconductive interconnector. A small power source capable of generating electricity continuously for a long period of time can be obtained by using an aqueous methanol solution with a high volume energy density as liquid fuel. The small power source can be operated as the built-in power source of a movable telephone, a book type personal computer, a portable video movie camera or the like, and its continuous use for a long period of time becomes possible when fuel previously prepared is supplied in small portions.

Furthermore, in order to reduce the frequency of supply of the fuel greatly as compared with the case described above, it is effective to use the small power source as a battery charger by combining the power source with the charger of, for example, a movable telephone, a book type personal computer or a portable video movie camera, which is equipped with a secondary cell, and attaching the power source to a part of the case for accommodation of such an apparatus. In this case, when used, such a portable electronic device is taken out of the case for accommodation and operated by the use of the secondary cell. When not used, the portable electronic device is accommodated in the case, so that the small fuel cell fixed in the case is connected to the secondary cell through the charger to charge the secondary cell. When the small power source is used in the manner described above, the capacity of the fuel container can be increased and the frequency of supply of the fuel can be greatly reduced.

According to the present invention, there can be provided a fuel cell that makes it possible to prevent a decrease of the generated output caused by the influence of impurities (e.g. metal ions) present in fuel, by reducing the production of an electrical short circuit between single cells which make a potential difference larger than that made by any other two of a plurality of single cells which hold a fuel container in common and are located in a plane and face to face with each other with the fuel container inserted between them; and an electronic device using said fuel cell.

### DESCRIPTION OF PREFERRED EMBODIMENTS

The best mode for carrying out the present invention is explained in detail with the following examples, which should not be construed as limiting the scope of the invention.

### EXAMPLE 1

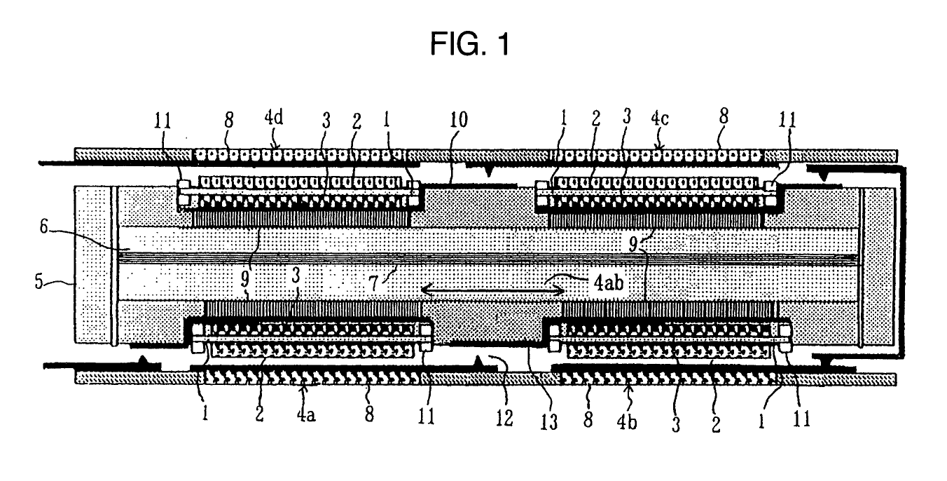

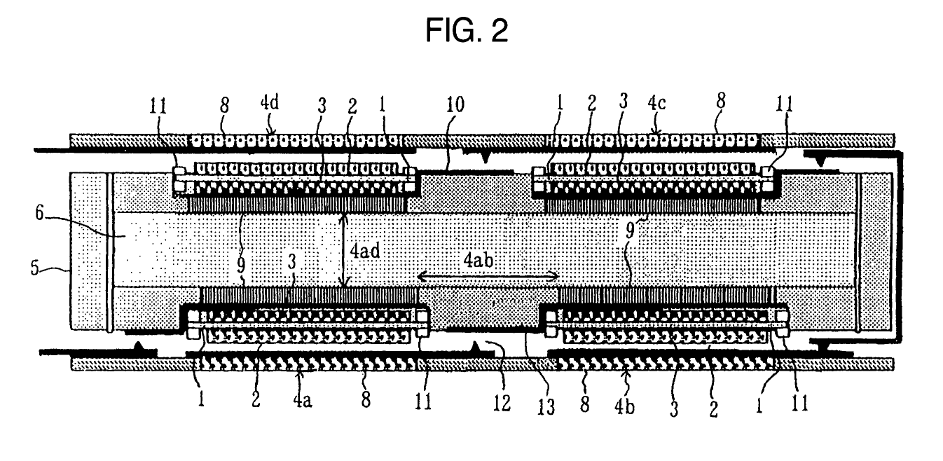

FIG. 1 is a cross-sectional view of a fuel cell of the present invention. FIG. 2 is a cross-sectional view of a fuel cell shown as a comparative example. The fuel cell of the present example is a direct methanol fuel cell (DMFC) using a 10 wt % aqueous methanol solution as fuel. The fuel cell of the present example comprises electrolyte membranes 1, cathodes 2, anodes 3, a barrier layer 7, grooves for aeration 8, grooves for liquid passage 9, a current-collecting plate 10, gaskets 11, an interconnector 12, electroconductive paste 13, a fuel container 5 and fuel 6. The fuel cell has a plurality of single cells formed through the fuel container 5. In the present example, half of the fuel cell is shown. Eight single cells are formed on the fuel cell 5 and are connected in series by the current-collecting plate 10. Although the electrolyte membrane 1 is provided in each single cell, it can be formed as one electrolyte membrane 1 on one and the same plane. The grooves for aeration 8 are provided in the fuel container 5 itself.

The cathode 2 has a catalyst layer (not shown) and a diffusion layer (not shown). As the catalyst layer of the cathode 2, a carbon-based powder carrier supporting thereon platinum fine particles as a catalyst is used. The anode 3 has a catalyst layer (not shown) and a diffusion layer (not shown). As the catalyst layer of the anode 3, a carbon-based powder carrier supporting thereon fine particles of platinum and ruthenium or a platinum-ruthenium alloy as a catalyst is used. The diffusion layers assure the drainability of water produced on the electrodes and the diffusibility of the fuel. Although carbon paper is used as each diffusion layer in the present example, electroconductive fiber may be used as the diffusion layer. The cathode 2 and the anode 3 are formed with the electrolyte 1 inserted between them, and the resulting assembly is called MEA 4.

The anode 3 was obtained as follows. A slurry was prepared by adding catalyst powder obtained by supporting dispersed fine particles of a platinum-ruthenium (atomic ratio: 1/1) alloy on a carbon carrier in an amount of 50 wt % to a water-alcohol mixed solvent [a mixed solvent of water, isopropanol and n-propanol (weight ratio: 20:40:40)] and using a 30% sulfonated perfluorocarbon electrolyte as a binder. Using the slurry, a porous film of about 20 μm in thickness was formed on one side of a 30% sulfonated perfluorocarbon electrolyte membrane of 50 μm in thickness by a silk screen printing method to obtain an anode having a predetermined planar shape.

The cathode 2 was obtained as follows. A slurry was prepared by adding catalyst powder obtained by supporting platinum fine particles on a carbon carrier in an amount of 30 wt % to a water-alcohol mixed solvent and using the above-mentioned electrolyte as a binder. Using the slurry, a porous film of about 25 μm in thickness was formed on the other side of the above-mentioned electrolyte membrane by a silk screen printing method to obtain a cathode having a predetermined planar shape.

As shown in the comparative fuel cell in FIG. 2, a plurality of such MEAs 4 were located in a plane so as to be in contact with a fuel container 5. In FIG. 2, the MEAs 4 are located in a plane on the top surface and under surface of the fuel container 5. The fuel container 5 contains fuel 6. A 10 wt % aqueous methanol solution is used as the fuel. The MEAs are electrically connected in series. In this case, MEA 4a, MEA 4b, MEA 4c and MEA 4d are electrically connected in series in that order. Therefore, although MEA 4a and MEA 4d make the largest potential difference, the distance 4ad between MEA 4a and MEA 4d is shorter than the distance between other MEAs which make a smaller potential difference, for example, the distance 4ab between MEA 4a and MEA 4b. Accordingly, there has been a fear that an electrical short circuit may be produced by impurities such as metal ions in the fuel, resulting in damage to the fuel cell as power source.

However, in the present example, as shown in FIG. 1, a sheet-shaped barrier layer 7 for electrical insulation is inserted, so that this sheet serves as a barrier layer against the impurities. Therefore, MEA having a potential at the shortest creeping distance from MEA 4a is the adjacent assembly MEA 4b, so that the potential gradient is reduced as compared with the comparative example. In the present example, the thickness of the fuel container 5 is 5 mm and the sheet-shaped barrier layer 7 of 0.1 mm is located in the middle of the fuel container 5. The distance between adjacent MEAs is 8 mm. When the voltage of each of MEAs 4a, 4b, 4c and 4d is 0.3 V, the potential gradient between the nearest MEAs in FIG. 2, i.e., the potential gradient between MEA 4a and MEA 4d is 0.9 V at a distance of 5 mm, namely, it is 0.18 V/mm. On the other hand, in the present example, the potential gradient between MEA 4a and MEA 4b is 0.6 V at a distance of 8 mm, namely, it is 0.075 V/mm. Thus, the potential gradient is slighter. Accordingly, the possibility of the damage by an electrical short circuit produced by impurities in the fuel could be reduced. A power source produced according to the present example was not damaged.

In the present example, the fuel cell produced by connecting the four MEAs in series was postulated. However, since an actual information apparatus, i.e., a personal computer or the like requires a voltage of 12 V, it is necessary to connect 40 to 30 MEAs of 0.3 to 0.4 V in series, so that the potential difference between MEAs is liable to be further increased. Even if a boosting circuit is used, it is necessary to connect 10 or more MEAs in series when the efficiency is taken into account. Even when the number of MEAs connected in series is increased, the damage to the power source can be prevented by reducing the potential gradient according to the present invention.

As a material for the sheet-shaped barrier layer 7, a polypropylene resin impermeable to the fuel was used. The sheet-shaped barrier layer 7 functions as a partition wall for preventing the passage of the methanol fuel. The sheet-shaped barrier layer 7 may be inserted between members obtained by dividing the fuel container or may be formed integrally with the fuel container. As a material for the sheet-shaped barrier layer 7, plastic materials and rubber materials, which are hardly permeable to methanol, may be used besides polypropylene resins. A material resistant to methanol is preferable. As to the shape of the sheet-shaped barrier layer 7, a portion of the barrier layer 7 may have a hole or the like, which permits passage of the fuel. The sheet-shaped barrier layer 7 preferably functions as a filter for capturing impurities such as metal ions.

As described above, according to the present example, there can be provided a fuel cell that makes it possible to reduce the production of an electrical short circuit between single cells which make a potential difference larger than that made by any other two of a plurality of single cells which hold a fuel container in common and are located in a plane and face to face with each other with the fuel container inserted between them, and to prevent markedly a decrease of the generated output caused by the influence of impurities (e.g. metal ions) present in the fuel by the above-mentioned reduction.

### EXAMPLE 2

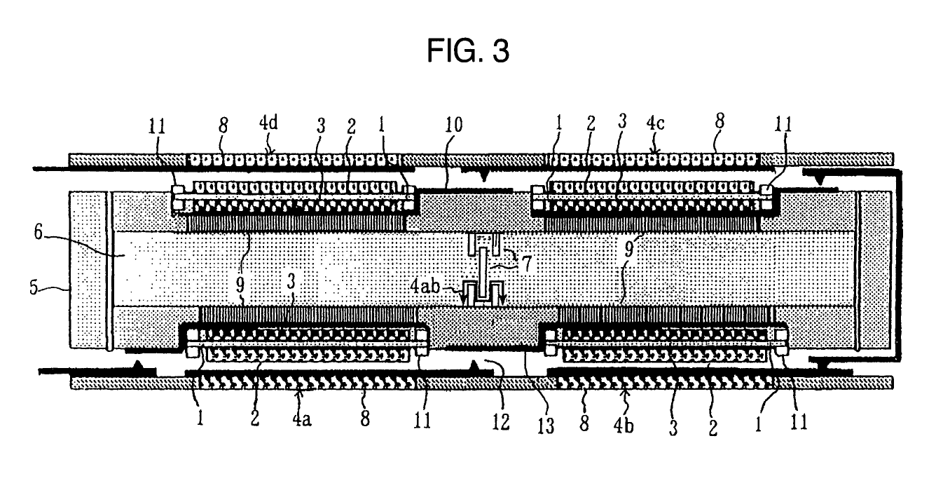

FIG. 3 is a cross-sectional view of a fuel cell of the present invention having another structure. The basic structure of this fuel cell is the same as that shown in FIG. 1, though in this fuel cell, the distance between MEAs located face to face with each other with a fuel container 5 inserted between them is longer than that described in Example 1. Therefore, a barrier layer 7 is provided as shown in FIG. 3, so that the creeping distance between adjacent MEAs located in one and the same plane may be increased. When a plurality of MEAs located in a plane are connected in series, the potential difference between MEAs facing each other is increased as in Example 1 and moreover, a large potential difference is made also between adjacent MEAs in some cases, depending on the order of the connection in series. In the present example, the barrier layer 7 is formed so that a flow path for fuel may be formed between adjacent MEAs by two projections and a thin sheet member held between them, in order to make the creeping distance between the adjacent MEAs larger than the linear distance between them. In the barrier layer 7, a space is formed so that fuel therein may flow through the barrier layer 7. According to the present example, the potential gradient can be reduced because the distance 4ab which impurities (e.g. metal ions) released into fuel by dissolution from a material for MEA 4a traverse to arrive at the adjacent assembly MEA 4b is substantially increased. As a material for the barrier layer 7, a polypropylene resin is used as in Example 1 and plastic materials and rubber materials, which are hardly permeable to methanol, may be used besides polypropylene resins.

In the present example, single cells are located in a plane and face to face with each other on the fuel container 5. Although the barrier layer 7 between single cells facing each other is unnecessary when single cells are located merely in a plane on the fuel container 5, this barrier layer 7 may be set.

In the present example, the barrier layer 7 may be combined with the sheet-shaped barrier layer 7 formed between the MEAs facing each other in Example 1. Owing to this combination, the production of an electrical short circuit between MEAs became more difficult, so that the occurrence of deterioration of performance characteristics and damage became difficult. The barrier layer 7 may be formed not only on the wall surface of the fuel container but also on a member with which the fuel comes into contact. The barrier layer 7 may be composed of very small concavities and convexities of one or more microns. The barrier layer 7 preferably functions as a filter for capturing impurities such as metal ions.

As described above, also in the present example, it is possible to reduce the production of an electrical short circuit between single cells which make a potential difference larger than that made by any other two of a plurality of single cells which hold the fuel container 5 in common and are located in a plane and face to face with each other with the fuel container inserted between them, and to prevent markedly a decrease of the generated output caused by the influence of impurities (e.g. metal ions) present in the fuel by the above-mentioned reduction.

### EXAMPLE 3

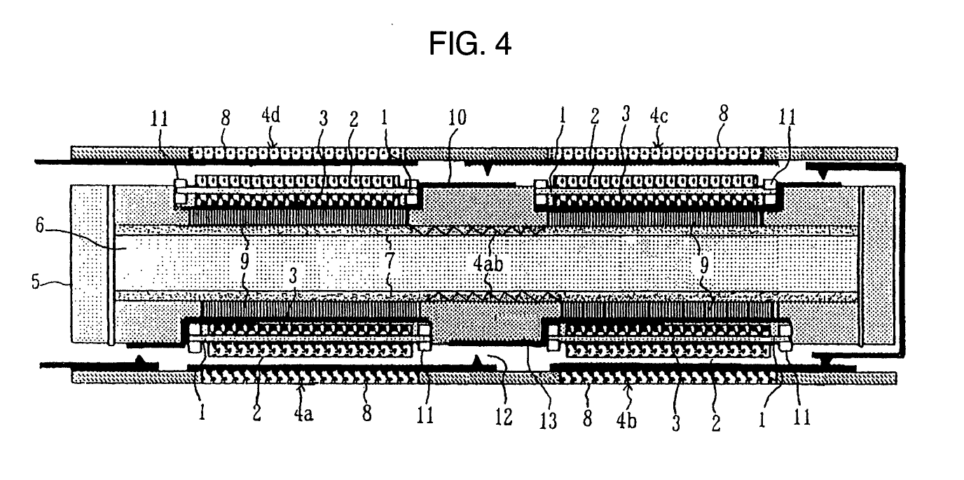

FIG. 4 is a cross-sectional view of a fuel cell of the present invention having still another structure. The fuel cell of the present example has the same structure as in Example 1 except that a barrier layer 7 made of a fuel-permeable insulating porous material is located on each of surfaces in contact with MEAs 4 in a fuel container 5. In this fuel cell, the distance between MEAs located face to face with each other with the fuel container 5 inserted between them is longer than that described in Example 1. Therefore, the barrier layers 7 are provided as shown in FIG. 4, so that the creeping distance between adjacent MEAs located in one and the same plane may be increased. The barrier layer 7 made of the porous material has pores for supplying fuel and discharging carbon dioxide. In the present example, a plastic having an average pore size of 200 μm was used as the porous material. As the pore size, any pore size may be employed so long as it permits fuel transfer by capillary action and imparts a function of holding the fuel.

As the porous material, ceramics and other inorganic material may be used besides plastics. As the pores formed in the barrier layer 7 made of the porous material, spaces are continuously formed from the MEA side to the fuel container side but are not linearly formed, namely, a pathway for fuel transfer is wound to be lengthened, by portions constituting the skeleton of the porous material. In FIG. 4, the pathway for fuel transfer 4ab is schematically shown. This lengthening of the pathway for fuel transfer results in a decreased substantial potential gradient. Thus, owing to the employment of the barrier layer 7 made of the porous material, the production of an electrical short circuit between MEAs became difficult, so that a decrease of the generated output caused by the influence of impurities (e.g. metal ions) present in the fuel can be markedly prevented and that the occurrence of damage to the fuel cell became difficult.

Although the single cells are located in a plane and face to face with each other on the fuel container 5 in the present example, the barrier layer 7 can be formed also when the single cells are located either in a plane or face to face with each other.

### EXAMPLE 4

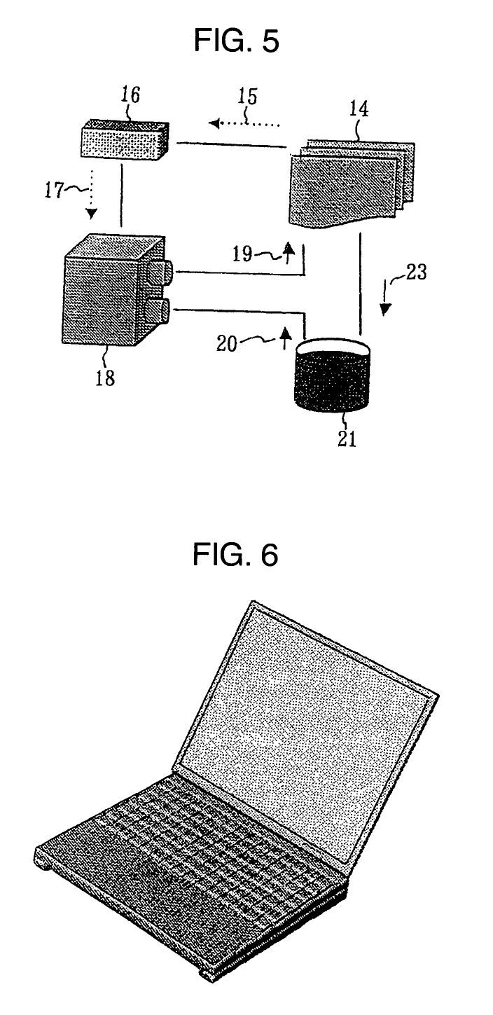

FIG. 5 is a block diagram showing the system of a personal computer incorporated with the fuel cell of the present invention described in any of Examples 1 to 4. FIG. 6 is a perspective view of a personal computer having the system shown in FIG. 5. In the present example, a power-generating portion composed of panel-shaped fuel cells is accommodated in the liquid crystal display of a notebook-sized personal computer. The surface of the power-generating portion has an air inlet composed of slits. In this personal computer, a container 21 for methanol fuel composed of an aqueous methanol solution having a predetermined concentration, a pump 18 and various sensors 16 are provided in the hinge portion. Suction of fuel 20 is carried out with the pump 18 and the fuel is supplied to the fuel cells 14 by introduction of fuel 19. The fuel is supplied by a command 17 based on information 15 given by the various sensors 16 in the fuel cells 14.

As described above, according to the present example, there can be provided a personal computer equipped with fuel cells that make it possible to reduce the production of an electrical short circuit between single cells which make a potential difference larger than that made by any other two of a plurality of single cells which hold a fuel container in common and are located in a plane and face to face with each other with the fuel container inserted between them, and to prevent a decrease of the generated output caused by the influence of impurities (e.g. metal ions) present in the fuel by the above-mentioned reduction.

It should be further understood by those skilled in the art that although the foregoing description has been made on embodiments of the invention, the invention is not limited thereto and various changes and modifications may be made without departing from the spirit of the invention and the scope of the appended claims.

1. A fuel cell comprising a plurality of single cells each obtained by forming an anode for oxidizing liquid fuel and a cathode for reducing oxygen with an electrolyte membrane inserted between them and a fuel container holding said fuel on which the single cells are integrally located, said fuel cell having a means for making the potential gradient between adjacent single cells among the above-mentioned single cells slighter than that given in the case of the linear distance between them.

2. A fuel cell according to claim 1, wherein said single cells are located on said fuel container so that the location may be at least one of location in a place or location in a facing-each-other manner.

3. A fuel cell according to claim 2, wherein said means for making the potential gradient between the adjacent single cells slighter than that given in the case of the linear distance between them is provided in at least one of the area between the aforesaid adjacent single cells located in a plane as described above and the area between the aforesaid single cells facing each other as described above.

4. A fuel cell according to claim 2, wherein said means for making the potential gradient between the adjacent single cells slighter than that given in the case of the linear distance between them is formed in one or more places or the whole of the area between the aforesaid adjacent single cells.

5. A fuel cell according to claim 2, wherein said means for making the potential gradient between the adjacent single cells slighter than that given in the case of the linear distance between them is an insulating film formed on the whole surface in said fuel container in at least one of the area between the aforesaid single cells located in a plane as described above and the area between the aforesaid single cells located face to face with each other as described above.

6. A fuel cell according to claim 5, wherein said insulating film is permeable or impermeable to fuel.

7. A fuel cell according to claim 2, wherein said means for making the potential gradient between the adjacent single cells slighter than that given in the case of the linear distance between them preferably has two projections formed in the whole area between the aforesaid adjacent single cells located in a plane as described above.

8. A fuel cell according to claim 7, wherein said means for making the potential gradient between the adjacent single cells slighter than that given in the case of the linear distance between them has two projections formed in the whole area between the aforesaid adjacent single cells located in a plane on each side as described above, and a flat plate formed between the aforesaid projections between the aforesaid single cells located face to face with the single cells located on the other side, so as to provide a flow path for the above-mentioned fuel.

9. A fuel cell according to claim 2, wherein said means for making the potential gradient between the adjacent single cells slighter than that given in the case of the linear distance between them is an insulating porous layer formed at least between the aforesaid adjacent single cells located in a plane as described above.

10. A fuel cell according to claim 9, wherein said insulating porous layer is formed on the whole surface in the above-mentioned fuel container.

11. A fuel cell according to claim 1, wherein said single cells are located in a plane and face to face with each other on said fuel container, and said means for making the potential gradient between the adjacent single cells slighter than that given in the case of the linear distance between them is an insulating porous layer formed on the whole surface in the above-mentioned fuel container.

12. A fuel cell according to claim 1, wherein said means for making the potential gradient between the adjacent single cells slighter than that given in the case of the linear distance between them is an insulating organic material.

13. A fuel cell comprising a plurality of single cells each obtained by forming an anode for oxidizing liquid fuel and a cathode for reducing oxygen with an electrolyte membrane inserted between them and a fuel container holding said fuel on which the single cells are integrally located, said fuel cell having a barrier layer for making the potential gradient between adjacent single cells among the above-mentioned single cells slighter than that given in the case of the linear distance between them.

14. A fuel cell according to claim 13, wherein said single cells are located on said fuel container so that the location may be at least one of location in a place or location in a facing-each-other manner.

15. A fuel cell according to claim 14, wherein said barrier layer is formed in one or more places or the whole of at least one of the area between the aforesaid adjacent single cells located in a plane as described above and the area between the aforesaid single cells facing each other as described above.

16. A fuel cell according to claim 14, wherein said barrier layer is an insulating film formed on the whole surface in said fuel container in at least one of the area between the aforesaid single cells located in a plane as described above and the area between single cells facing each other as described above.

17. A fuel cell according to claim 14, wherein said barrier layer comprises two projections formed in the whole area between the aforesaid adjacent single cells located in a plane on each side as described above and a flat plate formed between the aforesaid projections between the aforesaid single cells located face to face with the single cells located on the other side as described above, so as to have a flow path for the above-mentioned fuel.

18. A fuel cell according to claim 16, wherein said insulating film is an insulating porous layer.

19. An electronic device incorporated with fuel cells, wherein said fuel cell comprises a fuel cell according to claim 1.

20. An electronic device incorporated with fuel cells, wherein said fuel cell comprises a fuel cell according to claim 13.
